(19) United States
(12) Patent Application Publication
(10) Pub. No.: US 2013/0064468 A1
(43) Pub. Date: Mar. 14, 2013

(54) Methods and Apparatus for Image Analysis and Modification Using Fast Sliding Parabola Erosian

(71) Applicants: Peet Kask, Tabasalu (EE); Kaupo Palo, Haabneeme (EE)

(72) Inventors: Peet Kask, Tabasalu (EE); Kaupo Palo, Haabneeme (EE)

(73) Assignee: PerkinElmer Cellular Technologies Germany GmbH, Tallinn (EE)

(21) Appl. No.: 13/230,433

(22) Filed: Sep. 12, 2011

(51) Int. Cl. G06K 9/44

(52) U.S. Cl. 382/257

(57) ABSTRACT

Methods and apparatus are provided for image analysis and modification using a fast sliding parabola erosion. The methods include selecting a scan line in an image and performing a unidirectional left-hand pass followed by a unidirectional right-hand pass. The unidirectional passes are performed as loops with increasing distance. By utilizing simple unidirectional left-hand and right-hand passes along a scan line in an image, the erosion procedure is greatly simplified and computation times are significantly reduced.

### TECHNICAL FIELD

This invention relates generally to methods and apparatus for image analysis and modification. More particularly, in certain embodiments, the invention relates to methods and apparatus for image analysis and modification using a sliding parabola erosion.

### BACKGROUND

Image processing has a wide range of applications across many different industries and scientific fields. Common image processing applications include optical sorting, face detection, feature detection, medical image processing, microscope image processing, and morphological image processing. Image processing may be used to adjust or improve image quality, for example, by removing defects or adjusting for variations in lighting.

Erosion and dilation are two fundamental operations in image processing. While these operations are typically applied to binary images, they may also be applied to grayscale images. With binary images, the basic effect of erosion is to erode away the boundaries of foreground objects or pixels, which are typically white. As a result, areas of the foreground pixels become smaller, and holes in the background become larger.

Rolling ball transform is a known tool used in different applications of image analysis and imaging. Sliding parabola transform is a similar approach that is less frequently mentioned than rolling ball transform. Although sliding parabola transform has properties that make it potentially faster than rolling ball transform, existing, straightforward applications of both of these transforms are expensive in calculation time.

Both rolling ball transform and sliding parabola transform are opening operations in which an erosion operation is followed by a dilation operation. Since dilation can be executed as erosion applied to the negative image, however, the only necessary operation is erosion. In other words, it is sufficient if only one of these operations (i.e., erosion or dilation) is realized as a software procedure.

Sliding parabola erosion may be expressed as

Φ(i,j)=min_{x,y}{F(i+x,j+y)+a(x²+y²)}

where F is an input image, Φ is an eroded image, a is curvature of the parabola, i and j are coordinates of a pixel, and x and y are coordinates of a shift vector to any other (donor) pixel of the image.

Unfortunately, straightforward realization of sliding parabola erosion is computationally intensive, and efficient methods have not been developed or described. A need exists for an efficient and reliable sliding parabola erosion method.

### SUMMARY OF THE INVENTION

The apparatus and methods described herein are capable of performing efficient and reliable sliding parabola erosion. By utilizing simple unidirectional left-hand and right-hand passes along a scan line in an image, the erosion procedure is greatly simplified and computation times are significantly reduced.

The new methods and apparatus have a wide range of applications. Examples of such applications include leveling the background of a phase contrast image, determining the background image for spot detection, and calculating distance images from borders of detected objects, to name a few.

In one aspect, the invention is directed to a method for enhancing an image by performing a sliding parabola erosion operation, the method including the steps of: (a) providing an input image and copying the input image as an output image, then proceeding to step (b); (b) selecting a dimension d of the output image, then proceeding to step (c); (c) selecting a scan line of the output image in the dimension d, then proceeding to steps (d) and (e); (d) for each scan line s, performing a unidirectional left-hand pass as a loop with increasing distance by performing the following steps: (i) comparing each pixel p in scan line s with its closest neighboring pixel (distance of one pixel, shift=−1) if such a neighboring pixel exists and computing an intensity for the pixel p according to a sliding parabola erosion transform, accepting the computed intensity value in the output image for the pixel p if it changes, then identifying pixels that reduce the value of their partner pixel and proceeding to step (ii); and (ii) for the identified pixels that reduced the value of their partner pixel in the previous step, comparing each such pixel p with a pixel corresponding to the next consecutive shift if such a corresponding pixel exists and computing an intensity for the pixel p according to the sliding parabola erosion transform, accepting the computed intensity value in the output image for the pixel p if it changes, then identifying pixels that reduce the value of their partner pixel, and repeating step (ii) with the next consecutive shift until the computed intensity values for the pixels do not change from previous values, at which point the loop is broken; (e) for each scan line s, performing a unidirectional right-hand pass as a loop with increasing distance by performing the following steps: (i) comparing each pixel p in scan line s with its closest neighboring pixel (distance of one pixel, shift=+1) if such a neighboring pixel exists and computing an intensity for the pixel p according to a sliding parabola erosion transform, accepting the computed intensity value in the output image for the pixel p if it changes, then identifying pixels that reduce the value of their partner pixel and proceeding to step (ii); and (ii) for the identified pixels that reduced the value of their partner pixel in the previous step, comparing each such pixel p with a pixel corresponding to the next consecutive shift if such a corresponding pixel exists and computing an intensity for the pixel p according to the sliding parabola erosion transform, accepting the computed intensity value in the output image for the pixel p if it changes, then identifying pixels that reduce the value of their partner pixel, and repeating step (ii) with the next consecutive shift until the computed intensity values for the pixels do not change from previous values, at which point the loop is broken; (f) repeating step (c) with a new scan line s until there are no more scan lines in dimension d of the output image; and (g) repeating step (b) with a new dimension d until there are no more dimensions of the output image.

In certain embodiments the method includes performing an opening operation on the input image to produce a further output image, wherein steps (a) to (e) are performed on the input image to produce a first output image, and steps (a) to (e) are repeated with a negative of the first output image used as the ‘input image’ recited in steps (a) to (e), thereby producing the further output image. The first output image is the eroded image, and the second output image is the opened image.

In certain embodiments, the sliding parabola erosion transform is performed according to the equation Φ(i,j)=min_{x,y}{F(i+x,j+y)+a(x²+y²)}, where F is the input image, Φ is an eroded image resulting from the transform, a is one half parabola curvature, i and j are Cartesian pixel coordinates, and x and y are coordinates of a shift vector to a donor pixel of the input image.

In certain embodiments, the input image is a digital phase image (aka phase contrast image) and the further output image corrects the digital phase image for a variation of background intensity.

In certain embodiments, the input image includes one or more spots on a background with spatial intensity variation, and the method includes detecting and quantifying the one or more spots in the input image using the further output image.

In certain embodiments, the method includes determining a distance image corresponding to the input image, wherein the input image is a mask image of a detected object and a square root operation is performed on the output image to obtain the distance image, wherein the distance image graphically depicts at a given pixel the shortest distance from that pixel to a border of the detected object.

In another aspect, the invention is directed to an apparatus for enhancing an image by performing a sliding parabola erosion operation, the apparatus including: (I) a memory for storing a code defining a set of instructions; and (II) a processor for executing the set of instructions, wherein the code includes a sliding parabola erosion module to perform a sliding parabola erosion operation on an image, wherein the sliding parabola erosion module is configured to: (a) copy an input image as an output image, then proceed to step (b); (b) select a dimension d of the output image, then proceed to step (c); (c) select a scan line s of the output image in the dimension d, then proceed to steps (d) and (e); (d) for each scan line s, perform a unidirectional left-hand pass as a loop with increasing distance by performing the following steps: (i) compare each pixel p in scan line s with its closest neighboring pixel (distance of one pixel, shift=−1) if such a neighboring pixel exists and compute an intensity for the pixel p according to a sliding parabola erosion transform, accept the computed intensity value in the output image for the pixel p if it changes, then identify pixels that reduce the value of their partner pixel and proceed to step (ii); and (ii) for the identified pixels that reduced the value of their partner pixel in the previous step, compare each such pixel p with a pixel corresponding to the next consecutive shift if such a corresponding pixel exists and compute an intensity for the pixel p according to the sliding parabola erosion transform, accept the computed intensity value in the output image for the pixel p if it changes, then identify pixels that reduce the value of their partner pixel, and repeat step (ii) with the next consecutive shift until the computed intensity values for the pixels do not change from previous values, at which point the loop is broken; (e) for each scan line s, perform a unidirectional right-hand pass as a loop with increasing distance by performing the following steps: (i) compare each pixel p in scan line s with its closest neighboring pixel (distance of one pixel, shift=+1) if such a neighboring pixel exists and compute an intensity for the pixel p according to a sliding parabola erosion transform, accept the computed intensity value in the output image for the pixel p if it changes, then identify pixels that reduce the value of their partner pixel and proceed to step (ii); and (ii) for the identified pixels that reduced the value of their partner pixel in the previous step, compare each such pixel p with a pixel corresponding to the next consecutive shift if such a corresponding pixel exists and compute an intensity for the pixel p according to the sliding parabola erosion transform, accept the computed intensity value in the output image for the pixel p if it changes, then identify pixels that reduce the value of their partner pixel, and repeat step (ii) with the next consecutive shift until the computed intensity values for the pixels do not change from previous values, at which point the loop is broken; (f) repeat step (c) with a new scan line s until there are no more scan lines in dimension d of the output image; and (g) repeat step (b) with a new dimension d until there are no more dimensions of the output image.

In certain embodiments, the sliding parabola erosion module is configured to perform an opening operation on the input image to produce a further output image, wherein the module is configured to perform steps (a) to (e) on the input image to produce a first output image, and to repeat steps (a) to (e) with a negative of the first output image used as the ‘input image’ recited in steps (a) to (e), thereby producing the further output image.

In certain embodiments, the sliding parabola erosion module is configured to perform a sliding parabola erosion transform according to the equation Φ(i,j)=min_{x,y}{F(i+x, j+y)+a(x²+y²)}, where F is the input image, Φ is an eroded image resulting from the transform, a is one half parabola curvature, i and j are Cartesian pixel coordinates, and x and y are coordinates of a shift vector to a donor pixel of the input image.

In certain embodiments, the input image is a digital phase image (aka phase contrast image) and the further output image corrects the digital phase image for a variation of background intensity.

In certain embodiments, the input image includes one or more spots on a background with spatial intensity variation, and the sliding parabola erosion module is configured to detect and quantify the one or more spots in the input image using the further output image.

In certain embodiments, the sliding parabola erosion module is configured to determine a distance image corresponding to the input image, wherein the input image is a mask image of a detected object and the sliding parabola erosion module is configured to perform a square root operation on the output image to obtain the distance image, wherein the distance image graphically depicts at a given pixel the shortest distance from that pixel to a border of the detected object.

Elements of embodiments described with respect to a given aspect of the invention may be used in various embodiments of another aspect of the invention. For example, it is contemplated that features of dependent claims depending from one independent claim can be used in apparatus and/or methods of any of the other independent claims.

### BRIEF DESCRIPTION OF THE DRAWINGS

The objects and features of the invention can be better understood with reference to the drawing described below, and the claims.

FIGS. 1 and 2 are images depicting the results of operations performed on a row of an image in consecutive unidirectional passes, in accordance with an illustrative embodiment of the invention.

FIGS. 3 and 4 are flowcharts of a method for enhancing an image by performing a sliding parabola erosion operation, in accordance with an illustrative embodiment of the invention.

FIGS. 5 and 6 depict a phase contrast image of a sample that includes cells reconstructed from a z-stack of bright field images, in accordance with an illustrative embodiment of the invention.

FIG. 7 is an image having a slowly changing background and a plurality of bright spots, in accordance with an illustrative embodiment of the invention.

FIG. 8 is a modified version of the image in FIG. 7 in which the background variation has been removed using sliding parabola erosion, in accordance with an illustrative embodiment of the invention.

FIG. 9 is an image of a mask of a cytoplasm region of a cell, in accordance with an illustrative embodiment of the invention.

FIG. 10 is a distance image that was calculated from the image in FIG. 9 using sliding parabola erosion, in accordance with an illustrative embodiment of the invention.

FIGS. 11 and 12 are fluorescence images of about 75 cells, in accordance with an illustrative embodiment of the invention.

FIG. 13 is a graph depicting intensity at a fixed y-position in an example of digital phase image correction for non-uniform background, in accordance with an illustrative embodiment of the invention.

FIG. 14 is a graph depicting intensity of a column of a fluorescence image as a function of distance along the y-coordinate, corrected in accordance with an illustrative embodiment of the invention.

### DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

Throughout the description, where systems are described as having, including, or comprising specific components, or where processes and methods are described as having, including, or comprising specific steps, it is contemplated that, additionally, there are systems of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

The methods and apparatus described herein provide an elegant approach for performing sliding parabola erosion. High speeds (i.e., low computation times) are achieved by performing a sequence of consecutive one-dimensional operations. In effect, the task of performing sliding parabola erosion has been reduced to one-dimensional (1-D) erosion. The one-dimensional operations may be performed on two-dimensional (2-D) images or on images with more than two dimensions (e.g., three-dimensional images).

High speeds are achieved by organizing the 1-D sliding parabola erosion into consecutive left-hand and right-hand passes, by arranging a unidirectional pass as a loop with increasing distance, and by minimizing the number of operations in each unidirectional pass.

A left-hand pass has a negative shift coordinate, and a right-hand pass has a positive shift coordinate. Organizing the erosion into consecutive left-hand and right-hand passes greatly simplifies the procedure.

Also, in this approach, a unidirectional pass is performed as a loop with increasing distance. Specifically, in the first step (e.g., with a distance of one pixel), each pixel is compared to its closest neighbor. In the next step, only those pixels which had reduced the value of their partner pixel in the previous step are considered. The loop is broken when no changes have occurred. In other words, within a given step of the loop, the intensity of a pixel is either corrected or not corrected. For example, the intensity is corrected when the value calculated from intensity of a donor pixel and its distance is lower than the current pixel intensity. When at least one pixel has been corrected (i.e., the pixel has obtained a new value), regardless of the amount of the correction, the loop is not broken and the calculations continue.

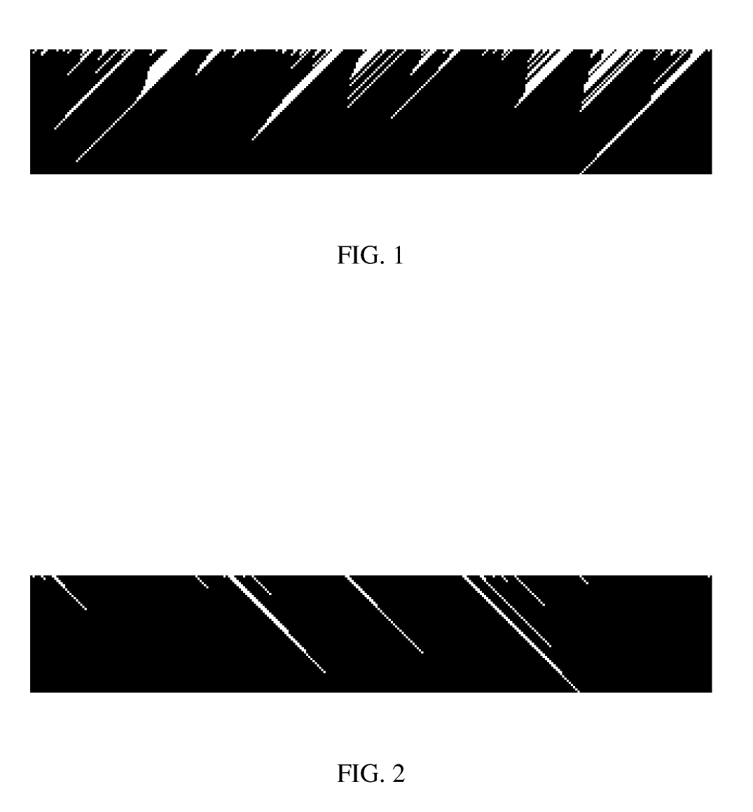

FIGS. 1 and 2 are images depicting the results of operations performed on a row of an image in consecutive unidirectional passes, in accordance with one embodiment of the invention. In FIG. 1, each pixel has been compared with its right-side neighbor. In FIG. 2, each pixel has been compared with its left-side neighbor. Each column in these figures represents the pixel number. Beginning with the top row in each of these figures, each row represents a calculation step (i.e., the first row is the first step, the nth row is the nth step). The row also represents the distance between pixels that were compared at each step. Specifically, the top row represents the first step with shift=−1. The next row (i.e., the second row) represents the second step with shift=−2, and so on. Pixels that changed their value during a calculation step are white, while pixels that did not change their value during a calculation step are black. The results in these figures indicate that the only pixels worth considering as donors are those that reduce the value of their partner in the previous step.

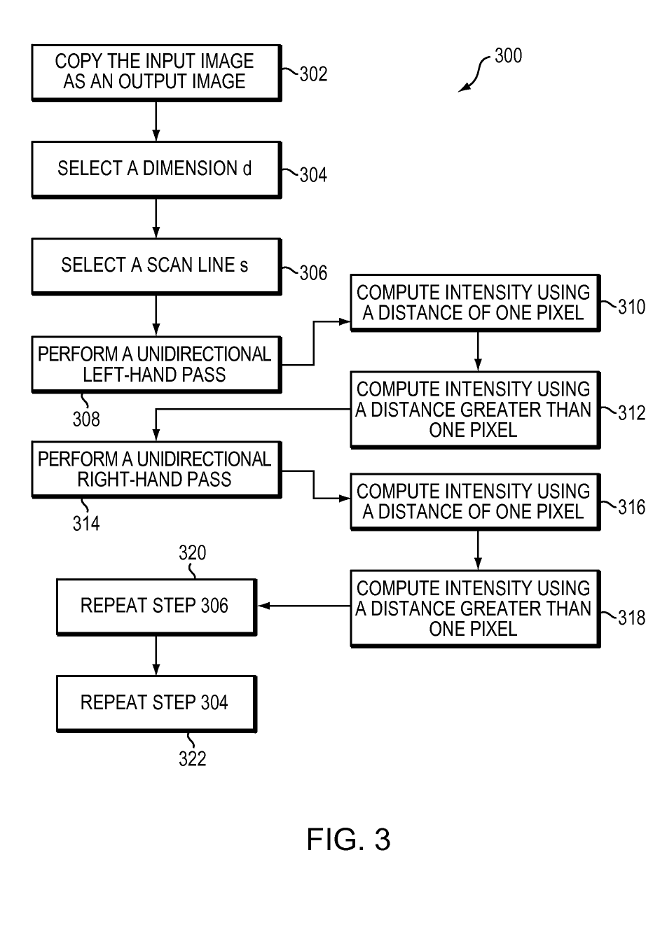

FIG. 3 is a flowchart of a method 300 for enhancing an image by performing a sliding parabola erosion operation, in accordance with an embodiment of the invention. At step 302, the method 300 includes providing an input image and copying the input image as an output image, then proceeding to step 304. At step 304, the method 300 includes selecting a dimension d of the output image, then proceeding to step 306. At step 306, the method 300 includes selecting a scan line s of the output image in the dimension d, then proceeding to steps 308 and 314.

At step 308, for each scan line s, the method 300 includes performing a unidirectional left-hand pass as a loop with increasing distance by performing the following steps. At step 310, the method 300 includes comparing each pixel p in scan line s with its closest neighboring pixel (distance of one pixel, shift=−1) if such a neighboring pixel exists and computing an intensity for the pixel p according to a sliding parabola erosion transform, accepting the computed intensity value in the output image for the pixel p if it changes, then identifying pixels that reduce the value of their partner pixel and proceeding to step 312. At step 312, the method 300 includes, for the identified pixels that reduced the value of their partner pixel in the previous step, comparing each such pixel p with a pixel corresponding to the next consecutive shift if such a corresponding pixel exists and computing an intensity for the pixel p according to the sliding parabola erosion transform, accepting the computed intensity value in the output image for the pixel p if it changes, then identifying pixels that reduce the value of their partner pixel, and repeating step 312 with the next consecutive shift until the computed intensity values for the pixels do not change from previous values, at which point the loop is broken.

At step 314, for each scan line s, the method 300 includes performing a unidirectional right-hand pass as a loop with increasing distance by performing the following steps. At step 316, comparing each pixel p in scan line s with its closest neighboring pixel (distance of one pixel, shift=+1) if such a neighboring pixel exists and computing an intensity for the pixel p according to a sliding parabola erosion transform, accepting the computed intensity value in the output image for the pixel p if it changes, then identifying pixels that reduce the value of their partner pixel and proceeding to step 318. At step 318, the method 300 includes, for the identified pixels that reduced the value of their partner pixel in the previous step, comparing each such pixel p with a pixel corresponding to the next consecutive shift if such a corresponding pixel exists and computing an intensity for the pixel p according to the sliding parabola erosion transform, accepting the computed intensity value in the output image for the pixel p if it changes, then identifying pixels that reduce the value of their partner pixel, and repeating step 318 with the next consecutive shift until the computed intensity values for the pixels do not change from previous values, at which point the loop is broken.

At step 320, the method 300 includes repeating step 306 with a new scan line s until there are no more scan lines in dimension d of the output image. Finally, at step 322, the method 300 includes repeating step 304 with a new dimension d until there are no more dimensions of the output image.

In one embodiment, the method 300 includes performing an opening operation on the input image to produce a further output image. Specifically, steps 302 to 318 are performed on the input image to produce a first output image, and steps 302 to 318 are repeated with a negative of the first output image used as the ‘input image’ recited in steps 302 to 318, thereby producing the further output image. In another embodiment, the sliding parabola erosion transform is performed according to the equation

Φ(i,j)=min_{x,y}{F(i+x,j+y)+a(x²+y²)},

where F is the input image, Φ is an eroded image resulting from the transform, a is one half parabola curvature, i and j are Cartesian pixel coordinates, and x and y are coordinates of a shift vector to a donor pixel of the input image.

In certain embodiments, the input image is a digital phase image (also referred to as a phase contrast image) and the further output image corrects the digital phase image for a variation of background intensity using the output image obtained by performing steps 302 to 318. In another embodiment, the input image includes one or more spots on a background with spatial intensity variation, and the method 300 includes detecting and quantifying the one or more spots in the input image using the further output image. The method may also include determining a distance image corresponding to the input image, wherein the input image is a mask image of a detected object and a square root operation is performed on the output image to obtain the distance image. The distance image graphically depicts at a given pixel the shortest distance from that pixel to a border of the detected object.

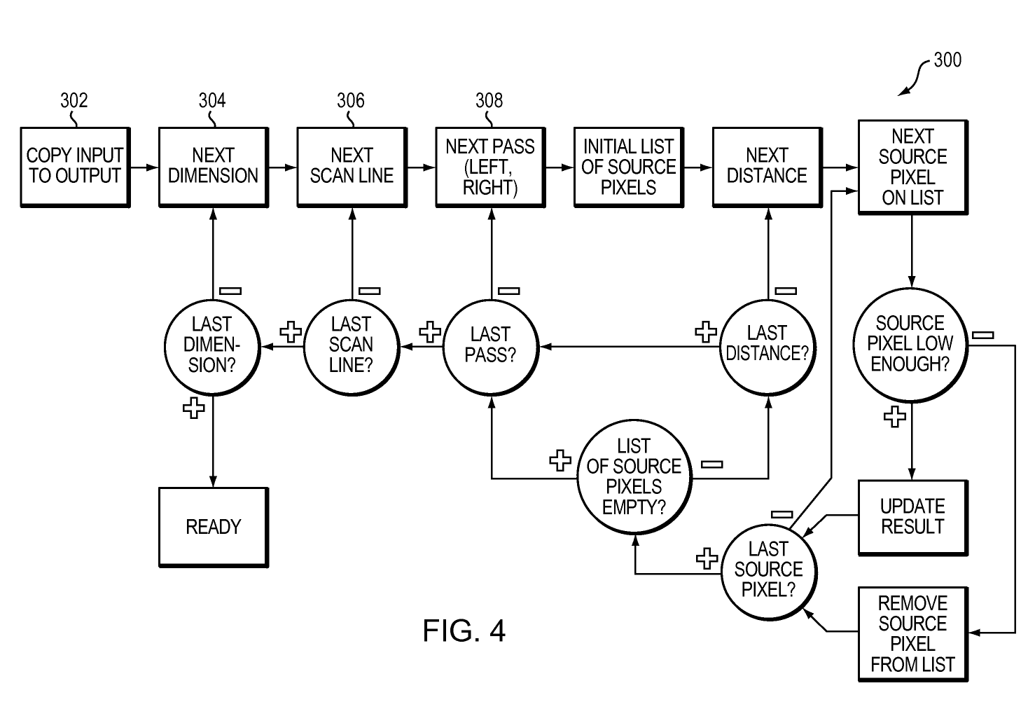

FIG. 4 is a flowchart depicting the method 300, in accordance with one embodiment of the invention. The squares in this figure represent particular method steps. The circles in this figure include questions for determining how the method is to proceed. Paths associated with a plus (+) sign are taken when the answer to a question is “yes.” Paths associated with a minus (−) sign are taken when the answer to a question is “no.”

The methods and apparatus described herein are equally applicable to data or images of any dimensionality. For example, at step 304 of the method 300, any of the three dimensions d may be selected for a 3-D output image. Because 3-D images generally have more pixels than 2-D images, calculation times are generally longer for 3-D images.

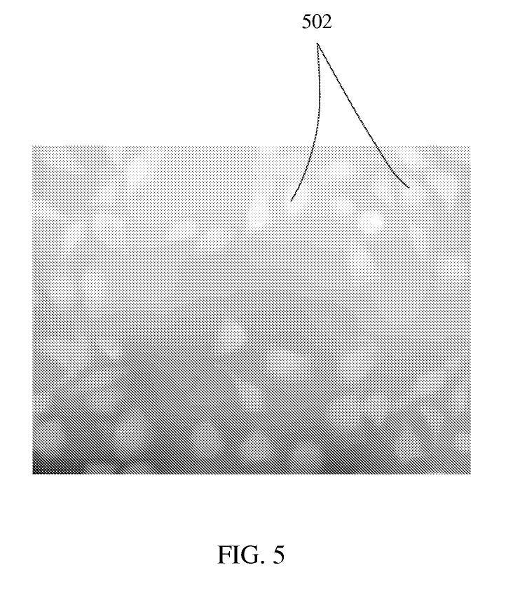

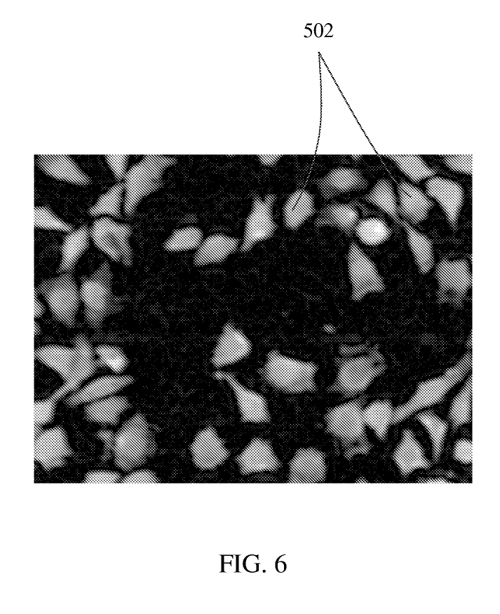

The methods and apparatus described herein have many different image processing applications. For example, referring to FIGS. 5 and 6, the algorithm may be used to level the background of a phase contrast image. The need to correct for a slow shift of a background image is a rather frequent task in image analysis. Digital phase images (aka phase contrast images) can be reconstructed, for example, from transmission images measured at different z-coordinates. Such reconstructed phase images are usually distorted because of artifacts of different kinds. One kind of artifact which can be corrected by the fast sliding parabola erosion described herein is a relatively slow shift of the background phase, for example, the light phase corresponding to a part of a sample without cells.

FIG. 5 depicts a phase contrast image of a sample that includes cells 502 reconstructed from a z-stack of bright field images. As depicted, the background in this image is not uniform. After applying the sliding parabola erosion algorithm, however, the background becomes uniform, as depicted in FIG. 6. FIG. 13 depicts another example of digital phase image correction for non-uniform background. In FIG. 13, the black line (1305) depicts intensity of a directly calculated phase image at a fixed y-position (y-445), and the green line (1310) depicts intensity of the fast sliding parabola erosion-corrected phase image.

Another application for the methods and apparatus described herein is analysis of an image for spot detection. It can be very useful to automatically detect and quantify small, intense spots on a background image with intensity that varies slightly. For example, two light signals may originate from biologically different sources, and a task of data analysis is to separate these two contributions.

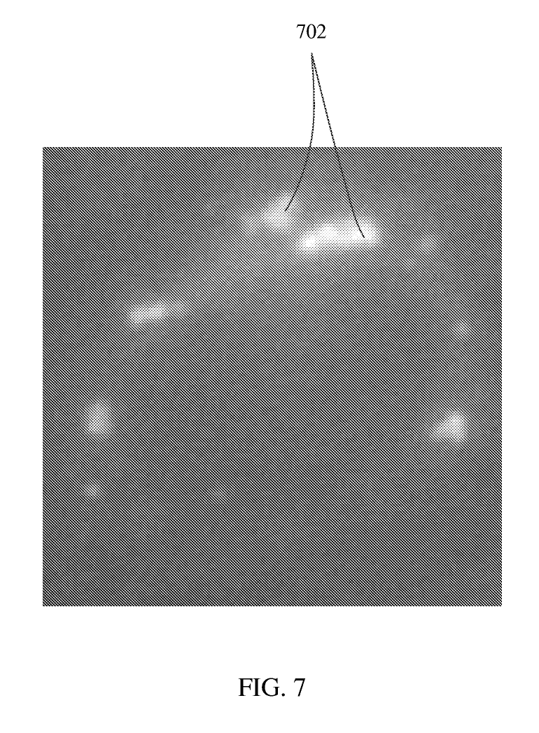

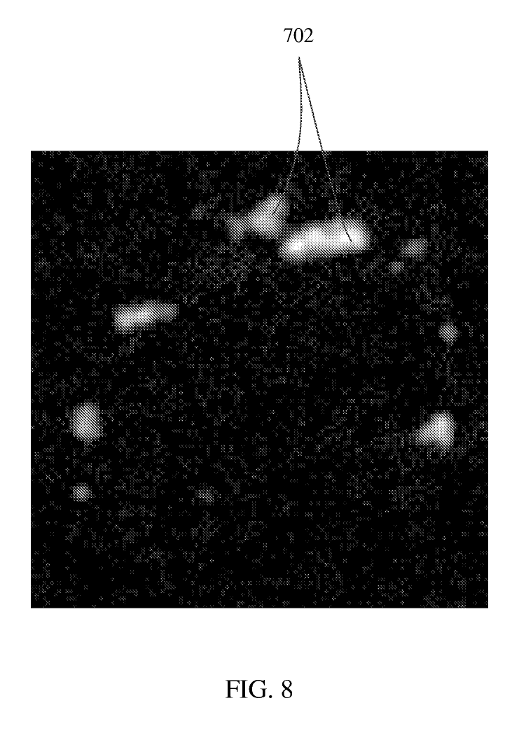

FIG. 7 shows an image having a slightly spatially-varying background and a plurality of bright spots 702. As depicted in FIG. 8, the background variation is removed using the sliding parabola erosion method described herein.

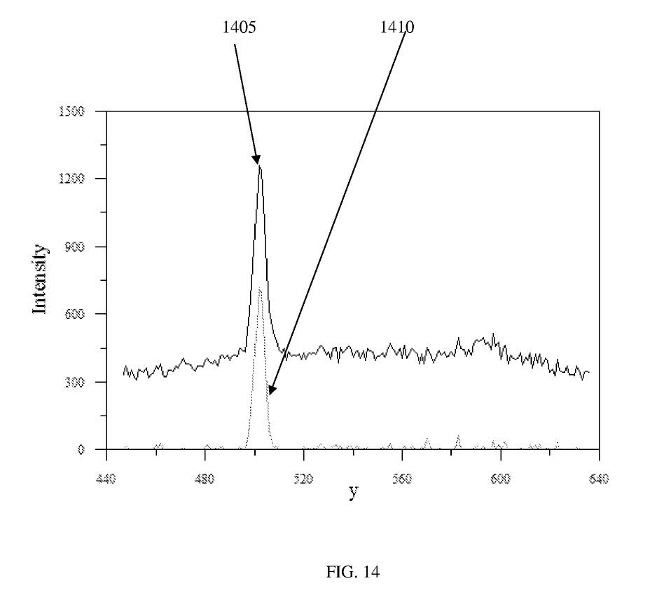

In FIG. 14, the upper line 1405 is the intensity of a fluorescence image along an image row x=671, through a cell with a spot peaking at y=502. The line tracks intensity from the lower border of the cell to the upper border of the cell. The lower line 1410 is the corresponding intensity of a corrected image using the sliding parabola erosion method described herein.

The new algorithm may also be used for the calculation of distance images from borders of detected objects. The task here is to calculate distance from a given pixel to the closest black pixel of a mask. For any black pixel, the distance is zero. However, for white pixels, the task is to find the closest black pixel and calculate the corresponding pixel-to-pixel distance. A straightforward algorithm—e.g., performing a double loop over all black and white pixels—would be an enormous waste of computation time. Use of the fast sliding parabola erosion technique described herein greatly reduces computation time.

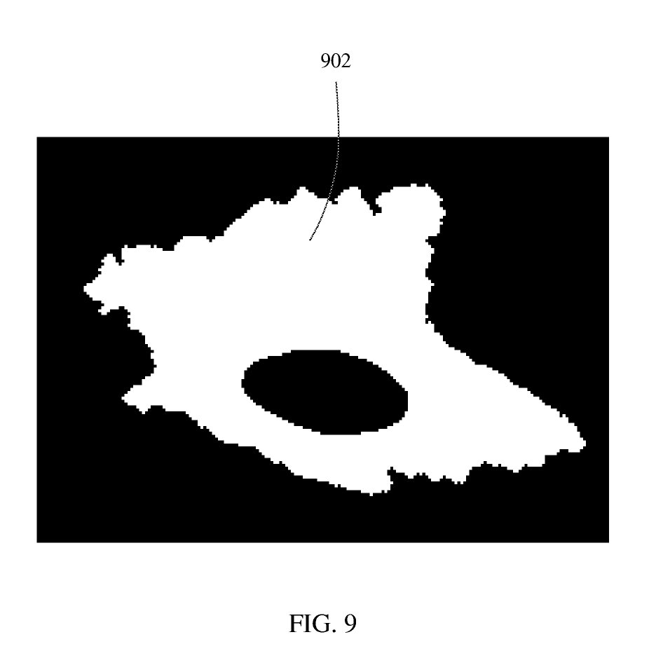

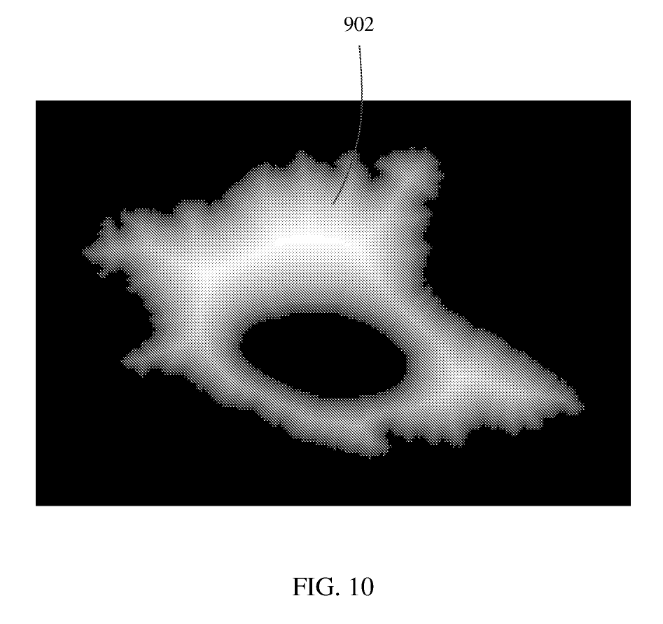

FIG. 9 depicts a mask of a cytoplasm region of a cell 902. FIG. 10 is a distance image that was calculated as the square root of the sliding parabola eroded image. Specifically, in this case, the sliding parabola algorithm was applied to the image in FIG. 9 to produce an eroded image. The value of each pixel in FIG. 10 was then set equal to the square root of the value of the corresponding pixel in the eroded image divided by parameter a. In other words, after selecting a sufficiently low value of the parameter a, sliding parabola erosion was applied to the mask image of FIG. 9, yielding Φ. The distance image was then calculated as d=SQRT(Φ/a).

In certain embodiments, the methods described above are implemented on a computer using computer software.

In one specific embodiment, to perform feature extraction, the software includes three building blocks to calculate intensity properties, calculate texture properties, and calculate morphology properties. To calculate threshold compactness features, the building block for calculating morphology properties is applied thereby ensuring that the family of threshold compactness features is ordered to be calculated. The user may then select the filter(s) to apply, including filters employing the fast sliding parabola erosion procedure described herein, and the user may choose numeric values of input parameters for filtering. In another embodiment, a wide set of features may be calculated automatically, whenever a classification or regression task is ordered. Later, when the tuning is completed (i.e., the relevant features have been identified), only the relevant features will be calculated.

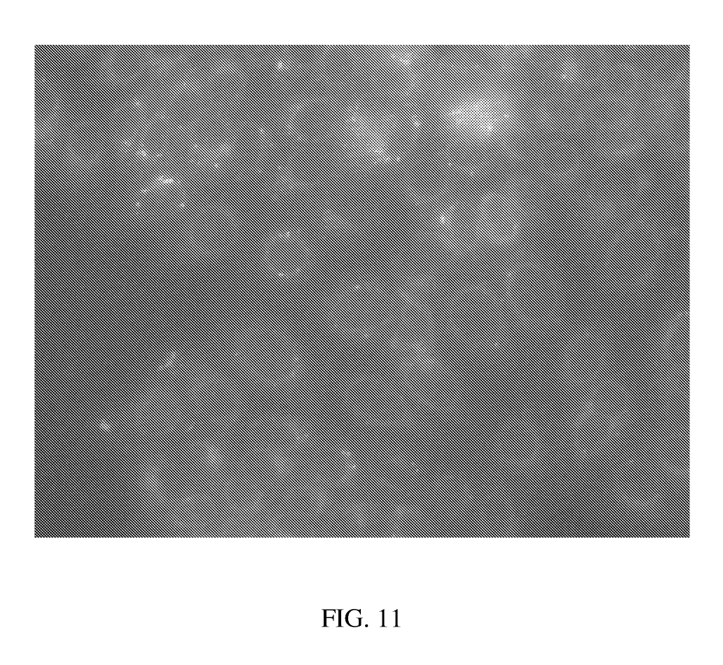

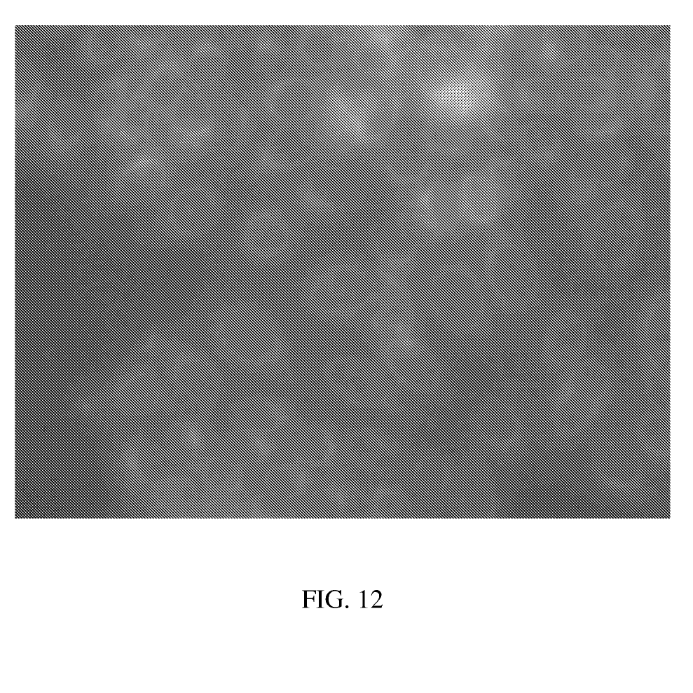

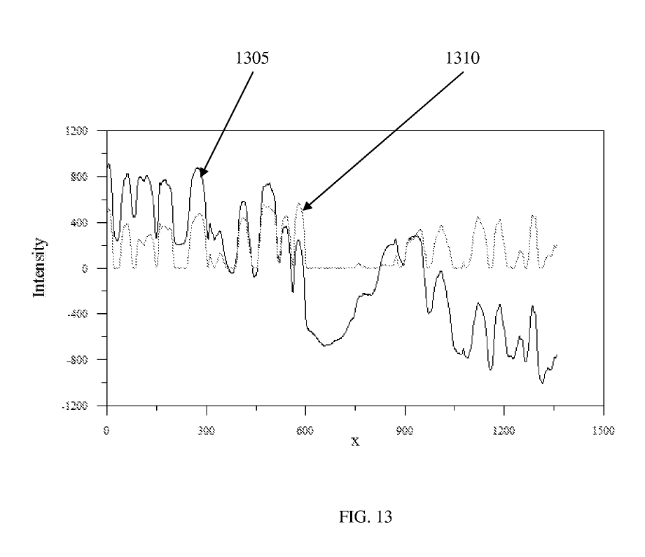

In one embodiment, the apparatus and methods described herein reduce computation times considerably by using the list of partner pixels and removing redundant partner pixels from the list on each step. This process alone reduces calculation time by a factor of ten in typical examples. For example, FIGS. 11 and 12 are fluorescence images of about 75 cells, in accordance with one embodiment of the invention. FIG. 11 is the original image, and FIG. 12 is the opened image, which was obtained by applying the sliding parabola erosion algorithm twice to the original image, at a parabola curvature of 2.0. The images in these figures are 1360×1024 pixel images. The calculation time for this operation was 0.17 seconds, using a Dell Latitude 630 (2.2 GHz laptop).

It should be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

A computer hardware apparatus may be used in carrying out any of the methods described herein. The apparatus may include, for example, a general purpose computer, an embedded computer, a laptop or desktop computer, or any other type of computer that is capable of running software, issuing suitable control commands, receiving graphical user input, and recording information. The computer typically includes one or more central processing units for executing the instructions contained in software code that embraces one or more of the methods described herein. The software may include one or more modules recorded on machine-readable media, where the term machine-readable media encompasses software, hardwired logic, firmware, object code, and the like. Additionally, communication buses and I/O ports may be provided to link any or all of the hardware components together and permit communication with other computers and computer networks, including the internet, as desired. The computer may include a memory or register for storing data.

In certain embodiments, the modules described herein may be software code or portions of software code. For example, a module may be a single subroutine, more than one subroutine, and/or portions of one or more subroutines. The module may also reside on more than one machine or computer. In certain embodiments, a module defines data by creating the data, receiving the data, and/or providing the data. The module may reside on a local computer, or may be accessed via network, such as the Internet. Modules may overlap—for example, one module may contain code that is part of another module, or is a subset of another module.

The computer can be a general purpose computer, such as a commercially available personal computer that includes a CPU, one or more memories, one or more storage media, one or more output devices, such as a display, and one or more input devices, such as a keyboard. The computer operates using any commercially available operating system, such as any version of the Windows™ operating systems from Microsoft Corporation of Redmond, Wash., or the Linux™ operating system from Red Hat Software of Research Triangle Park, N.C. The computer is programmed with software including commands that, when operating, direct the computer in the performance of the methods of the invention. Those of skill in the programming arts will recognize that some or all of the commands can be provided in the form of software, in the form of programmable hardware such as flash memory, ROM, or programmable gate arrays (PGAs), in the form of hard-wired circuitry, or in some combination of two or more of software, programmed hardware, or hard-wired circuitry. Commands that control the operation of a computer are often grouped into units that perform a particular action, such as receiving information, processing information or data, and providing information to a user. Such a unit can comprise any number of instructions, from a single command, such as a single machine language instruction, to a plurality of commands, such as a plurality of lines of code written in a higher level programming language such as C++. Such units of commands are referred to generally as modules, whether the commands include software, programmed hardware, hard-wired circuitry, or a combination thereof. The computer and/or the software includes modules that accept input from input devices, that provide output signals to output devices, and that maintain the orderly operation of the computer. The computer also includes at least one module that renders images and text on the display. In alternative embodiments, the computer is a laptop computer, a minicomputer, a mainframe computer, an embedded computer, or a handheld computer. The memory is any conventional memory such as, but not limited to, semiconductor memory, optical memory, or magnetic memory. The storage medium is any conventional machine-readable storage medium such as, but not limited to, floppy disk, hard disk, CD-ROM, and/or magnetic tape. The display is any conventional display such as, but not limited to, a video monitor, a printer, a speaker, an alphanumeric display. The input device is any conventional input device such as, but not limited to, a keyboard, a mouse, a touch screen, a microphone, and/or a remote control. The computer can be a stand-alone computer or interconnected with at least one other computer by way of a network. This may be an internet connection.

As used herein, an “image”—for example, an image of one or more cells—includes any visual representation, such as a photo, a video frame, streaming video, as well as any electronic, digital or mathematical analogue of a photo, video frame, or streaming video. Any apparatus described herein, in certain embodiments, includes a display for displaying an image or any other result produced by the processor. Any method described herein, in certain embodiments, includes a step of displaying an image or any other result produced via the method.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for enhancing an image by performing a sliding parabola erosion operation, the method comprising the steps of:
(a) providing an input image and copying the input image as an output image, then proceeding to step (b);
(b) selecting a dimension d of the output image, then proceeding to step (c);
(c) selecting a scan line s of the output image in the dimension d, then proceeding to steps (d) and (e);
(d) for each scan line s, performing a unidirectional left-hand pass as a loop with increasing distance by performing the following steps:
(i) comparing each pixel p in scan line s with its closest neighboring pixel (distance of one pixel, shift=−1) if such a neighboring pixel exists and computing an intensity for the pixel p according to a sliding parabola erosion transform, accepting the computed intensity value in the output image for the pixel p if it changes, then identifying pixels that reduce the value of their partner pixel and proceeding to step (ii); and
(ii) for the identified pixels that reduced the value of their partner pixel in the previous step, comparing each such pixel p with a pixel corresponding to the next consecutive shift if such a corresponding pixel exists and computing an intensity for the pixel p according to the sliding parabola erosion transform, accepting the computed intensity value in the output image for the pixel p if it changes, then identifying pixels that reduce the value of their partner pixel, and repeating step (ii) with the next consecutive shift until the computed intensity values for the pixels do not change from previous values, at which point the loop is broken;
(e) for each scan line s, performing a unidirectional right-hand pass as a loop with increasing distance by performing the following steps:
(i) comparing each pixel p in scan line s with its closest neighboring pixel (distance of one pixel, shift=+1) if such a neighboring pixel exists and computing an intensity for the pixel p according to a sliding parabola erosion transform, accepting the computed intensity value in the output image for the pixel p if it changes, then identifying pixels that reduce the value of their partner pixel and proceeding to step (ii); and
(ii) for the identified pixels that reduced the value of their partner pixel in the previous step, comparing each such pixel p with a pixel corresponding to the next consecutive shift if such a corresponding pixel exists and computing an intensity for the pixel p according to the sliding parabola erosion transform, accepting the computed intensity value in the output image for the pixel p if it changes, then identifying pixels that reduce the value of their partner pixel, and repeating step (ii) with the next consecutive shift until the computed intensity values for the pixels do not change from previous values, at which point the loop is broken;
(f) repeating step (c) with a new scan line s until there are no more scan lines in dimension d of the output image; and
(g) repeating step (b) with a new dimension d until there are no more dimensions of the output image.

2. The method of claim 1, wherein the method comprises performing an opening operation on the input image to produce a further output image, wherein steps (a) to (e) are performed on the input image to produce a first output image, and steps (a) to (e) are repeated with a negative of the first output image used as the ‘input image’ recited in steps (a) to (e), thereby producing the further output image.

3. The method of claim 1, wherein the sliding parabola erosion transform is performed according to the equation Φ(i,j)=min_{x,y} {F(i+x, j+y)+a(x²+y²)}, where F is the input image, Φ is an eroded image resulting from the transform, a is one half parabola curvature, i and j are Cartesian pixel coordinates, and x and y are coordinates of a shift vector to a donor pixel of the input image.

4. The method of claim 2, wherein the input image is a digital phase image (aka phase contrast image) and the further output image corrects the digital phase image for a variation of background intensity.

5. The method of claim 2, wherein the input image comprises one or more spots on a background with spatial intensity variation, and the method comprises detecting and quantifying the one or more spots in the input image using the further output image.

6. The method of claim 1, wherein the method comprises determining a distance image corresponding to the input image, wherein the input image is a mask image of a detected object and a square root operation is performed on the output image to obtain the distance image, wherein the distance image graphically depicts at a given pixel the shortest distance from that pixel to a border of the detected object.

7. An apparatus for enhancing an image by performing a sliding parabola erosion operation, the apparatus comprising:
(I) a memory for storing a code defining a set of instructions; and
(II) a processor for executing the set of instructions, wherein the code comprises a sliding parabola erosion module to perform a sliding parabola erosion operation on an image, wherein the sliding parabola erosion module is configured to:
(a) copy an input image as an output image, then proceed to step (b);
(b) select a dimension d of the output image, then proceed to step (c);
(c) select a scan line s of the output image in the dimension d, then proceed to steps (d) and (e);
(d) for each scan line s, perform a unidirectional left-hand pass as a loop with increasing distance by performing the following steps:
(i) compare each pixel p in scan line s with its closest neighboring pixel (distance of one pixel, shift=−1) if such a neighboring pixel exists and compute an intensity for the pixel p according to a sliding parabola erosion transform, accept the computed intensity value in the output image for the pixel p if it changes, then identify pixels that reduce the value of their partner pixel and proceed to step (ii); and
(ii) for the identified pixels that reduced the value of their partner pixel in the previous step, compare each such pixel p with a pixel corresponding to the next consecutive shift if such a corresponding pixel exists and compute an intensity for the pixel p according to the sliding parabola erosion transform, accept the computed intensity value in the output image for the pixel p if it changes, then identify pixels that reduce the value of their partner pixel, and repeat step (ii) with the next consecutive shift until the computed intensity values for the pixels do not change from previous values, at which point the loop is broken;
(e) for each scan line s, perform a unidirectional right-hand pass as a loop with increasing distance by performing the following steps:
(i) compare each pixel p in scan line s with its closest neighboring pixel (distance of one pixel, shift=+1) if such a neighboring pixel exists and compute an intensity for the pixel p according to a sliding parabola erosion transform, accept the computed intensity value in the output image for the pixel p if it changes, then identify pixels that reduce the value of their partner pixel and proceed to step (ii); and
(ii) for the identified pixels that reduced the value of their partner pixel in the previous step, compare each such pixel p with a pixel corresponding to the next consecutive shift if such a corresponding pixel exists and compute an intensity for the pixel p according to the sliding parabola erosion transform, accept the computed intensity value in the output image for the pixel p if it changes, then identify pixels that reduce the value of their partner pixel, and repeat step (ii) with the next consecutive shift until the computed intensity values for the pixels do not change from previous values, at which point the loop is broken;
(f) repeat step (c) with a new scan line s until there are no more scan lines in dimension d of the output image; and
(g) repeat step (b) with a new dimension d until there are no more dimensions of the output image.

8. The apparatus of claim 7, wherein the sliding parabola erosion module is configured to perform an opening operation on the input image to produce a further output image, wherein the module is configured to perform steps (a) to (e) on the input image to produce a first output image, and to repeat steps (a) to (e) with a negative of the first output image used as the ‘input image’ recited in steps (a) to (e), thereby producing the further output image.

9. The apparatus of claim 7, wherein the sliding parabola erosion module is configured to perform a sliding parabola erosion transform according to the equation Φ(i,j)=min_{x,y} {F(i+x, j+y)+a(x²+y²)}, where F is the input image, Φ is an eroded image resulting from the transform, a is one half parabola curvature, i and j are Cartesian pixel coordinates, and x and y are coordinates of a shift vector to a donor pixel of the input image.

10. The apparatus of claim 8, wherein the input image is a digital phase image (aka phase contrast image) and the further output image corrects the digital phase image for a variation of background intensity.

11. The apparatus of claim 8, wherein the input image comprises one or more spots on a background with spatial intensity variation, and the sliding parabola erosion module is configured to detect and quantify the one or more spots in the input image using the further output image.

12. The apparatus of claim 7, wherein the sliding parabola erosion module is configured to determine a distance image corresponding to the input image, wherein the input image is a mask image of a detected object and the sliding parabola erosion module is configured to perform a square root operation on the output image to obtain the distance image, wherein the distance image graphically depicts at a given pixel the shortest distance from that pixel to a border of the detected object.
